(19) United States
(12) Patent Application Publication
(10) Pub. No.: US 2002/0069897 A1
(43) Pub. Date: Jun. 13, 2002

(54) Tank cleaning apparatus and method

(76) Inventor: David L. Emrey, Greensboro, NC (US)

Correspondence Address: WALTER L. BEAVERS, 326 SOUTH EUGENE STREET, GREENSBORO, NC, 27401, US

(21) Appl. No.: 09/730,999

(22) Filed: Dec. 7, 2000

(51) Int. Cl. B08B 9/093

(52) U.S. Cl. 134/22.18; 134/167 R

(57) ABSTRACT

An apparatus and method are provided for cleaning the inside of large industrial tanks. The apparatus comprises a nozzle that is movably positioned on a stanchion that can be mounted on top of a tank, whereby said nozzle can be extended into and retracted from the tank as required.

### BACKGROUND OF THE INVENTION

1. Field of the Invention

The invention herein pertains to cleaning the inside of large industrial tanks and the like, and in particular provides an apparatus and method for doing the same.

2. Description of the Prior Art and Objectives of the Invention

Industrial materials of all kinds are commonly produced, mixed, reacted and/or stored by manufacturers in large tanks. It is often important, if not critical, that industrial material produced or stored in a tank is not contaminated with residue from former material. Consequently, there has been considerable invention in the relevant art to develop effective and efficient means for cleaning the inside of large industrial tanks of various sizes.

The prior art discloses many nozzle heads such as a tank washing nozzle head as is utilized in the present invention. While the nozzle heads vary slightly in shape, size, and structure, most are generally hollow and spherical, with many outlets protruding from the outer surface to allow for water or other cleaning liquid to pass through.

Further, the prior art discloses tank washing devices in which the cleaning apparatus is mounted inside the tank and stays in the tank at all times. Such devices are prone to clogging or malfunction when product material is being made or stored inside the tank.

The prior art also discloses motor driven tank washing devices. These devices are substantially more complex to operate and expensive to produce than the present invention.

Furthermore, certain prior tank washing devices must be hand held while the device is in operation. In addition, the operator often has to stand over the tank, insert the device into the tank, and move the device around in all directions in a wand-like manner to effectively clean the tank.

Thus, with the problems and disadvantages as outlined above, the present invention was conceived and one of its objectives is to provide an effective and efficient apparatus for cleaning the inside of large industrial tanks, and a method for doing the same.

Another objective of the invention is to provide a simple and relatively inexpensive apparatus for cleaning the inside of large tanks.

It is still another objective to provide a tank cleaning apparatus that can be operated with only minimal involvement or supervision of personnel.

It is a further objective to provide a tank cleaning apparatus that does not require manually holding it during the cleaning operation.

It is yet another objective to provide a tank cleaning apparatus that can be lowered into the tank for cleaning, and retracted once cleaning operations are complete.

It is a further objective to provide a tank cleaning apparatus that can be pivotally mounted and held in a vertical upright position for cleaning, and then positionable horizontally when not in use.

It is also another objective to provide a tank cleaning method that can be easily carried out by minimally trained personnel.

Various other objectives and advantages of the present invention will become apparent to those skilled in the art as a more detailed description is set forth below.

### SUMMARY OF THE INVENTION

The aforesaid and other objectives are realized by providing tank cleaning apparatus having a nozzle that is movably positioned on a stanchion which can be mounted on the top of a tank, whereby said nozzle can be extended into and retracted from the tank. A method for cleaning a tank utilizing the retractable nozzle is also disclosed.

In the present invention, a nozzle comprising a nozzle head and nozzle conduit is movably positioned on a stanchion such that the nozzle can be extended into and retracted from a tank. A supply line is connected to the upper end of the nozzle and furnishes pressurized water or other cleaning fluid which is sprayed by the nozzle head located at the lower end. The stanchion is pivotally connected to the tank in an upright position for cleaning operations, and then lowered to a horizontal position when not in use. A lever locks the nozzle into a desired position, either in or out of the tank.

In addition, the present invention provides for a method of cleaning a tank utilizing the retractable nozzle movably attached to the tank.

### DESCRIPTION OF THE PREFERRED EMBODIMENT

A nozzle is movably positioned on a stanchion such that the nozzle can be extended into and retracted from a tank. The nozzle comprises a nozzle conduit and nozzle head, which are connected to each other, preferably by male and female threading, respectively. The nozzle head, nozzle conduit and stanchion are made of steel.

The nozzle head consists of a tank washing nozzle head as is commonly known and used in the industry on tank washing devices. The nozzle head is a metal structure made of steel and comprises a hollow spherical structure, preferably having an inside diameter of 3.8 cm. Numerous hollow cylindrical structures, preferably 1.6 cm in length, extend outward from all areas of the outer surface of the sphere. Each cylindrical structure has a small hole at its end that allows water or other cleaning fluid to pass through. At the base of the spherical structure is a circular opening. An open-ended cylindrical structure extends outwardly from said circular opening, preferably having a length of 2.2 cm. In the preferred embodiment, the cylindrical structure has female threading along its inner surface, enabling the nozzle head to be connected to the nozzle conduit via male threading.

The nozzle conduit comprises a long, hollow cylindrical structure, preferably about 90 cm in length and about 5.1 cm in diameter. Both ends of the nozzle conduit have male threading. A threaded coupler is attached to the lower end of the nozzle conduit via threading, and the nozzle head is connected to the other end of the threaded coupler, also via threading. Threaded couplers of various lengths and diameters can be used to accommodate nozzle heads of various size. In addition, threaded couplers of various lengths can be used so that the nozzle head can be inserted to required depths inside a tank, thereby enabling the apparatus to be used in many tanks. Furthermore, the operator is able to position the nozzle at a depth in the tank which will yield the optimum cleaning results for a particular size. This results in greater efficiency and productivity by reducing cleaning time and materials.

The stanchion preferably comprises a rectangular tubular structure, about 90 cm in length, and having four equal sides of about 5.1 cm width. Two opposing sides of the stanchion are perforated with holes having a diameter of about 1 cm. The holes are centered along the sides and are spaced about 1.3 cm apart from each other. The other two opposing sides of the stanchion have a continuous opening or slot therealong, having a width of about 1 cm. The opening begins at about 2 cm above the lower end of the stanchion, and continues to a point about 14 cm below the upper end thereof.

A planar boom is movably connected to a sliding member contained inside the stanchion, through one of the above described continuous openings. The boom preferably has a rectangular shape with a vertical length of about 15.2 cm and a horizontal width of about 6.4 cm. The sliding member preferably has a rectangular, tubular shape and construction similar to that of the stanchion, however, it is slightly smaller in size so that it can easily move up and down the inside of the stanchion. Two metal, circular collars are connected to the side of the boom opposite of the side connected to the stanchion. The collars are affixed to the outer surface of the nozzle conduit at the conduit's approximate mid-point, and securely holds the nozzle conduit to the boom, to thereby connect the nozzle to the stanchion. In the preferred embodiment, a handle is connected to the sliding member through the continuous opening located on the side opposite the boom.

The sliding member contained inside the stanchion allows the boom to be moved up and down the length of the continuous opening. A spring is also contained inside the stanchion near the top. The spring acts as a biasing mechanism on the boom (and consequently the nozzle connected to the boom), for pulling it upwardly. The stanchion comprises a means to hold the boom in place (against the upward force of the spring) at various points along the stanchion. Preferably, a lever is located outside of the stanchion, on the side opposite the boom. The lever is pivotally connected to a conventional tightening member located inside the stanchion, through the continuous or slotted opening. Pushing downward on the lever causes the tightening member to urge a sliding member tightly against the inside of the stanchion. This prevents any further movement of the boom, and holds the boom and nozzle in place. Consequently, the nozzle can be moved and held to any point along the entire length of the continuous opening along the side of the stanchion. This enables the nozzle to be lowered into and raised out of a tank while the stanchion is affixed thereto. By removal from the tank during normal production operations, the nozzle head is not prone to clogging or malfunction. However, by remaining fixed to the tank, the apparatus can be easily and quickly lowered for cleaning. Furthermore, no personnel are needed to hold the apparatus at any point during or after the cleaning operations.

A lower flange is located near the bottom end of the nozzle conduit, preferably about 18.4 cm from the nozzle conduit's lower end. The lower flange encircles but does not necessarily touch the nozzle conduit, which is made of steel, and has a diameter of about 15.2 cm and a thickness of about 1.3 cm. A resilient sealing ring, made of rubber, plastic or other like material, approximately 0.6 cm thick, is attached to the underside of the lower flange. The ring can be attached to the flange via glue or otherwise. The ring is preferably positioned 0.6 cm from the outer edge of the flange. The lower flange is connected to an upper flange positioned about 2.5 cm above the lower flange on the nozzle conduit. The upper flange preferably has a diameter of about 10.2 cm and thickness of about 1.3 cm. Threaded members extend downward from the upper flange and are threadably affixed in openings in the upper surface of the lower flange. The threaded members are not threadably affixed to the upper flange, but rather float in openings provided therein. Compression coil springs encircle the threaded members. When the nozzle is lowered into a tank opening for cleaning, the lower flange completely covers the opening and acts as a lid to prevent the escape of any liquid. The ring on the underside of the lower flange seals the lower flange to the tank when in position. The compression springs act as shock absorbers to enable the lower flange to slightly retract when pushed against a tank, further enhancing the seal between the lower flange and tank. This increases efficiency by reducing cleaning materials otherwise wasted through a leaking flange.

The base of the stanchion is preferably pivotally attached to a tank via an L-shaped swivel footplate. A shoulder screw with a handle connects the stanchion to the footplate. The shoulder screw is inserted through a hole in one part of the footplate which is parallel to the upright stanchion and into the continuous opening at the base of the stanchion on the side opposite the boom and nozzle. The shoulder screw is threadably connected to a tightening member inside the stanchion. A handle is attached to the shoulder screw on the side. The footplate is placed directly on top of the tank near the tank's opening and connected to the tank via welding or bolts that run through holes in the footplate and top of the tank. When the handle is rotated in a clockwise manner, the shoulder screw is turned and the tightening member urges the stanchion against the footplate, holding it securely in place. In addition, a detent lock pin is inserted through an opening in the footplate and stanchion as an additional locking means for holding the apparatus in position. A metal wire or string can be used to attach to the lock pin to the footplate so the pin is not lost when it is taken out of the footplate.

For cleaning, the apparatus is placed in a straight upright vertical position and held there by rotating the handle and shoulder screw in a clockwise manner and inserting the lock pin. After cleaning, the stanchion is released by removing the lock pin and turning the handle in a counter-clockwise motion thereby releasing the tightening member from the stanchion and allowing the apparatus to position itself horizontally on the tank. The perforated hole on the footplate is slightly larger than the shoulder screw so that the stanchion can be raised approximately two centimeters when the shoulder screw is disengaged. This allows the stanchion to rest flat on the surface of the tank during cleaning operations, while at the same time providing sufficient clearance for the stanchion to be rotated horizontally after cleaning. The horizontal storage position of the apparatus allows for greater working space during non-cleaning time, further enhancing the invention's contribution to production efficiency.

A hollow, cylindrical metal coupler, approximately 6.4 cm long, is connected to the upper end of the nozzle conduit. Female threading is located along the inside of the lower portion of the coupler so that it can be connected to male threading located at the nozzle conduit's upper end. The upper portion of the structure is shaped so that a supply line can be securely affixed. The supply line provides water or other cleaning liquid which travels through the nozzle conduit for ultimately spraying from the nozzle head.

### BRIEF DESCRIPTION OF THE DRAWINGS

FIG. 1 illustrates a front-view of the preferred apparatus in an upright position with the nozzle positioned above a tank;

FIG. 2 shows a front-view of the preferred apparatus in operation with the nozzle lowered into the tank;

FIG. 3 pictures a cross-sectional inside view of the portion of the stanchion in which the disengaged lever connects to a released tightening member located inside the stanchion;

FIG. 4 depicts an enlarged cross-sectional of the exploded inside view of FIG. 3, with the lever engaged and tightening member locked in place;

FIG. 5 features a top-view of a tank with an opened lid and with a portion of the nozzle head as seen along line 5-5 of FIG. 1;

FIG. 6 pictures the tank of FIG. 5 but without the nozzle head and with the tank lid closed;

FIG. 7 shows a side-view of the preferred apparatus positioned in a dormant position on the tank;

FIG. 8 depicts a cross-sectional view of the upper and lower flanges on the nozzle conduit; and

FIG. 9 illustrates a cross-sectional view of the inside of the base of the stanchion.

### DETAILED DESCRIPTION OF THE DRAWINGS AND OPERATION OF THE INVENTION

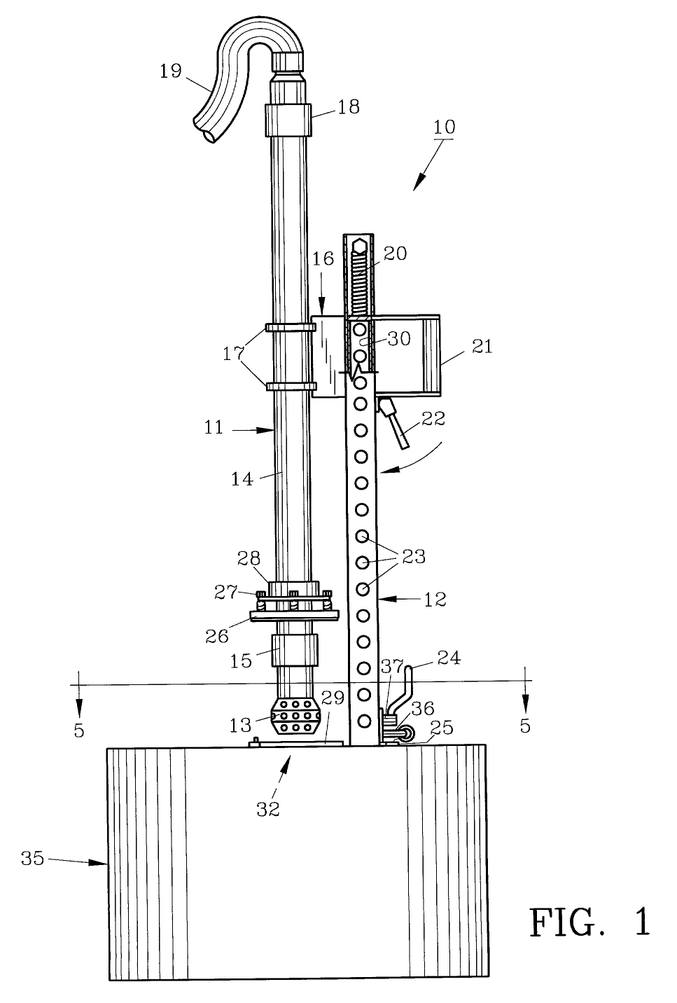

For a better understanding of the invention, turning now to the drawings, FIG. 1 illustrates preferred cleaning apparatus 10 in combination with tank 35. Apparatus 10 comprises nozzle 11 movably positioned on stanchion 12 having holes 23. Apparatus 10 is made of a durable, strong metal that is resistant to corrosion such as stainless steel. Nozzle 11 comprising nozzle conduit 14 and standard nozzle head 13, are connected via threaded coupler 15 at the lower end of nozzle conduit 14. Nozzle head 13 and nozzle conduit 14 can also be connected via screws, nuts and bolts, welding or the like.

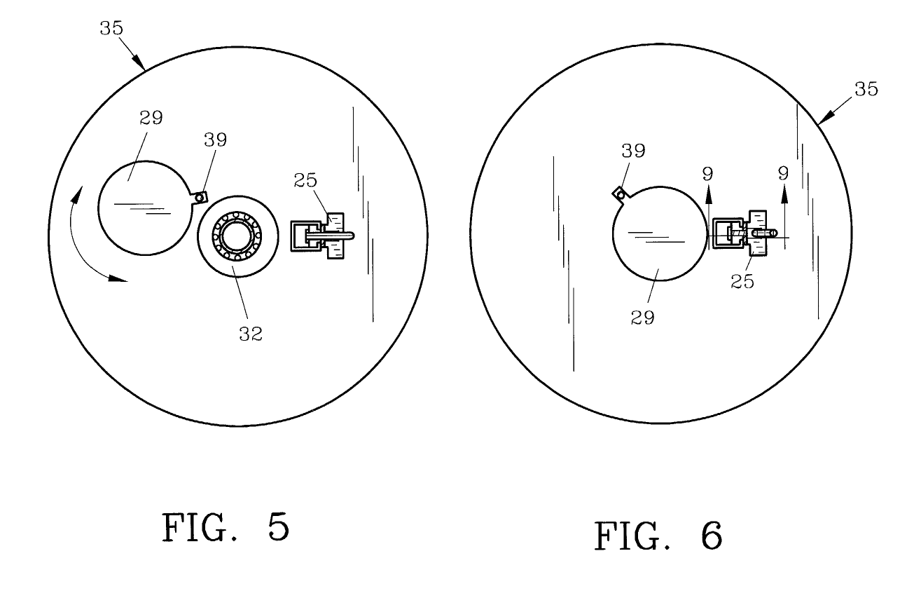

Tank 35 defines opening 32 and comprises lid 29 which is positioned to cover opening 32. Preferably, lid 29 is connected to tank 35 via pivotable member 39 (as shown in FIGS. 5 and 6) which enables lid 29 to be moved to expose opening 32 while remaining fixed to tank 35.

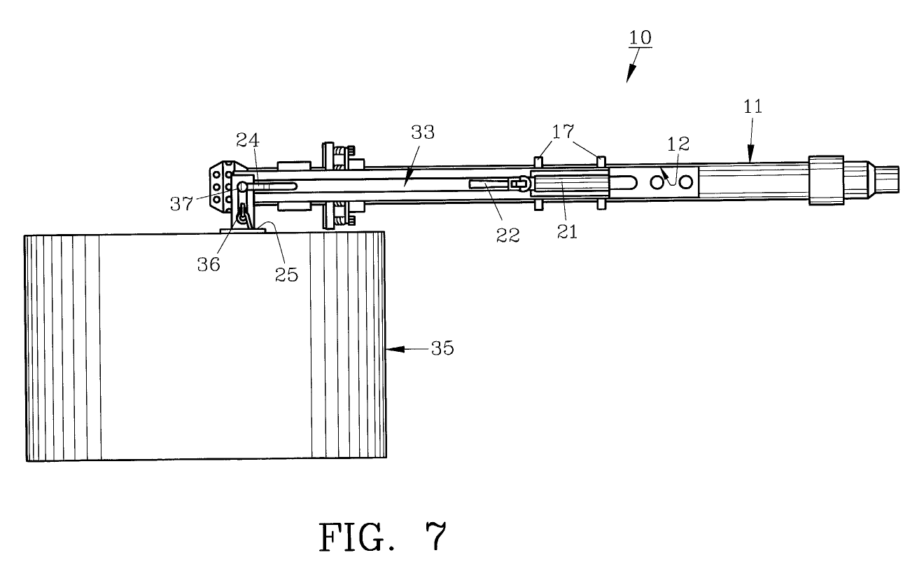

Flexible supply line 19 is connected to nozzle conduit 14 via coupler 18. Nozzle 11 is connected to rectangular tubular stanchion 12 via planar boom 16. Stanchion 12 can also be of a cylindrical or other tubular shape. Boom 16 is connected through slot 33 (as shown in FIG. 7) to sliding member 30 (FIG. 1) located inside stanchion 12. Boom 16 supports two collars 17 that hold nozzle conduit 14 at its approximate mid-point, as shown in FIG. 1.

Apparatus 10 comprises a pivotable means that allows apparatus 10 to be moved from a vertical upright position to a horizontal position on tank 35. In the preferred embodiment, stanchion 12 is pivotally connected to tank 35 via swivel footplate 25 and shoulder screw 37 with handle 24 (as shown in FIG. 9), which can be loosened to allow apparatus 10 to be moved from a vertical upright position (as shown in FIG. 1) to a horizontal position (as shown in FIG. 7). Shoulder screw 37 is rotatably connected to tightening member 38 inside stanchion 12 (as shown in FIG. 9). When handle 24 is moved in a clockwise motion, shoulder screw 37 likewise turns, creating a tighter connection between it and tightening member 38, and forcing stanchion 12, firmly against footplate 25. This tightening action securely holds apparatus 10 in an upright posture. Detent lock pin 36 provides an additional means for securely holding apparatus 10. Footplate 25 is mounted on the top of the tank via screws, nuts and bolts, welding or the like.

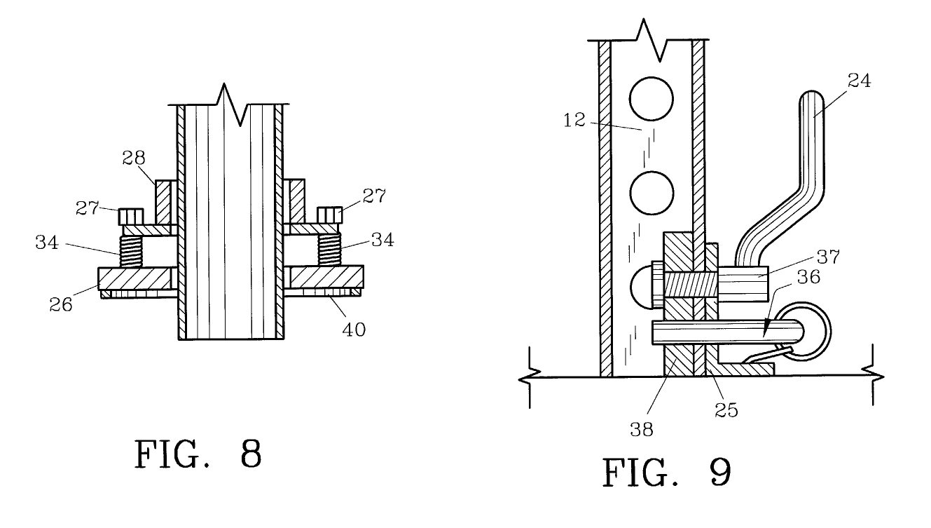

Lower flange 26 encircles (but does not necessarily touch) nozzle conduit 14 and is held in place by upper flange 28 which is permanently affixed to nozzle conduit 14, such as by welding or the like, and is connected to upper flange 28 via threaded members 27. Threaded members 27 pass through upper flange 28 but are not threadly affixed, and in fact “float” in openings provided therein. Compression springs 34 (as shown in FIG. 8) encircle threaded members 27. Lower flange 26 has sealing ring 40 on its lower surface (as shown in FIG. 8) to enhance the seal between lower flange 26 and the top surface of tank 35. Sealing ring 40 can be made of rubber, plastic or other resilient material.

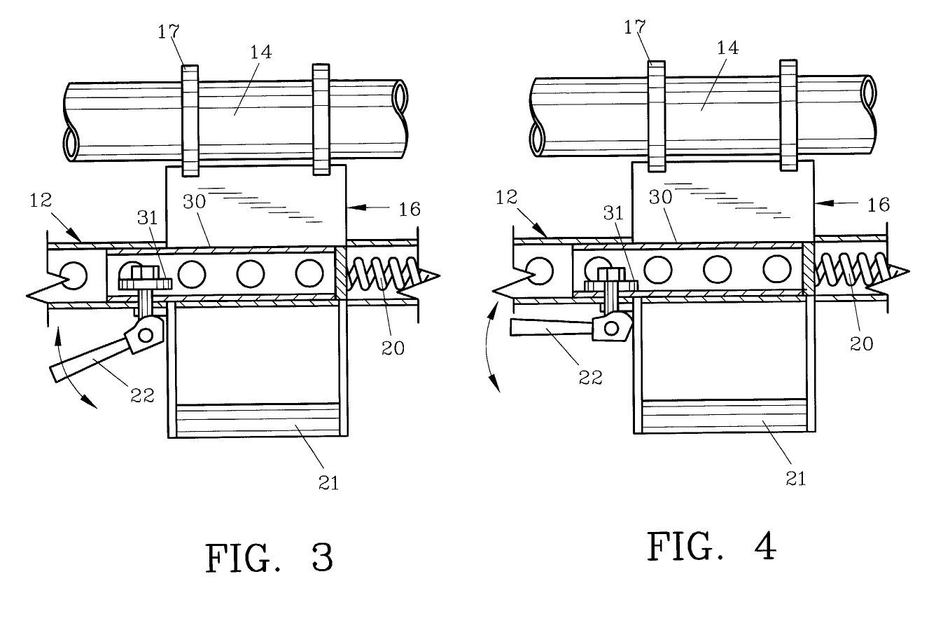

As also seen in FIGS. 1 and 4, spring 20 acts as a biasing mechanism on nozzle 14. Stanchion 12 comprises a means for holding nozzle 14 in place. Preferably, boom 16 and nozzle 14 are held in place against the upward force of spring 20 by tightening member 31 contained inside stanchion 12 (as shown in FIG. 4), which is connected to lever 22. When lever 22 is pushed downwardly tightening member 31 forces sliding member 30 against an inner wall of stanchion 12, holding boom 16 in place against the biasing mechanism of spring 20. Stanchion 12 also comprises a means for releasing said nozzle. Preferably said means comprises lever 22. When lever 22 is pushed upwardly, tightening member 31 is released from sliding member 30 (as shown in FIG. 3), and boom 16 and sliding member 30 are then free to move.

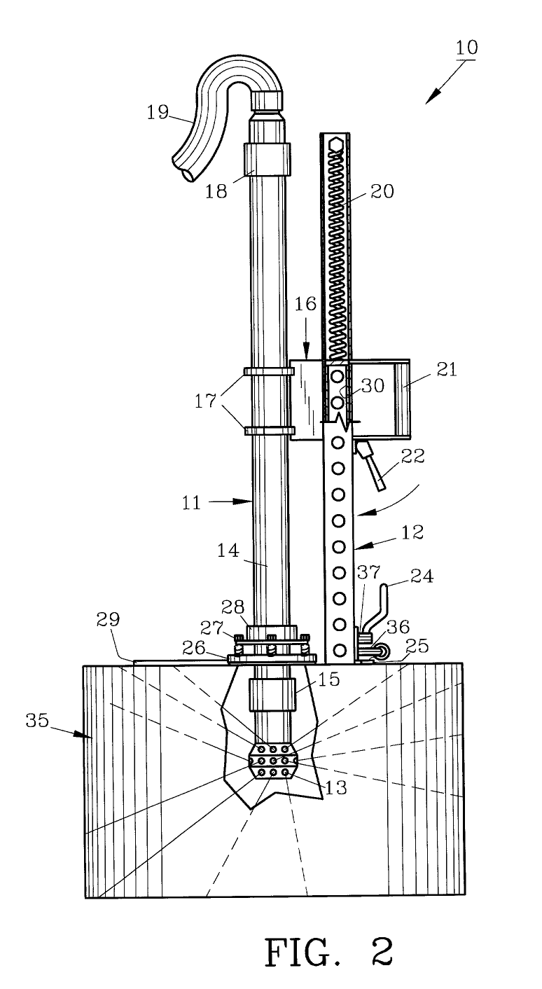

The following is a description of a method of using apparatus 10: Tightening member 31 is released from sliding member 30, allowing nozzle 11 to be lowered from its position in FIG. 1 to the position shown in FIG. 2. After being lowered to the desired position for cleaning, nozzle 11 is held in position by once again engaging tightening member 31 by pushing downwardly on lever 22. Lid 29 is moved via pivotable member 39 (as shown in FIG. 5) to expose tank opening 32 through which nozzle 11 can be selectively directed through. Cleaning liquid is forced through supply line 19 and out nozzle head 13 to spray/clean the inside of tank 35. After cleaning operations are complete, nozzle 11 is raised from tank 35 and returned to the position shown in FIG. 1. Nozzle 11 can then be positioned horizontally on tank 35 (as shown in FIG. 7) by releasing shoulder screw and handle 24, and lid 29 can be placed over tank opening 32 (as shown in FIG. 6).

Various components such as drain spigots and hoses are not shown as the illustrations and examples provided herein are for explanatory purposes only and are not intended to limit the scope of the appended claims.

I claim:

1. Tank cleaning apparatus comprising:
a stanchion, a nozzle, said nozzle movably positioned on said stanchion whereby said nozzle can be extended into and retracted from a tank during cleaning.

2. The tank cleaning apparatus of claim 1 wherein said nozzle comprises a nozzle head and a nozzle conduit, said nozzle conduit attached to said nozzle head.

3. The tank cleaning apparatus of claim 2 further comprising a supply line, said supply line attached to said nozzle conduit.

4. The tank cleaning apparatus of claim 1 wherein said stanchion further comprises a means to release said nozzle.

5. The tank cleaning apparatus of claim 1 further comprising a boom, said boom attached to said nozzle and to said stanchion.

6. The tank cleaning apparatus of claim 1 further comprising a lower flange, said lower flange attached to said nozzle.

7. The tank cleaning apparatus of claim 6 wherein said tank flange is circular, a sealing ring, said sealing ring affixed to said tank flange.

8. The tank cleaning apparatus of claim 1 further comprising a spring, said spring affixed to said stanchion and to said nozzle for biasing said nozzle.

9. The tank cleaning apparatus of claim 1 further comprising a pivotable means joined to said stanchion that allows said apparatus to be moved from a vertical upright position to a horizontal position.

10. Cleaning apparatus and a tank in combination, said tank comprising:
a receptacle, said receptacle defining an opening, and a movable lid, said lid positioned to cover said opening;
said cleaning apparatus comprising:
a stanchion, said stanchion mounted on said tank, a nozzle, said nozzle movably positioned on said stanchion whereby said nozzle can be selectively directed through said opening.

11. The combination of claim 10 wherein said lid comprises a pivotable member, said pivotable member enabling said lid to be moved to expose said opening while said lid remains fixed to said tank.

12. The combination of claim 10 wherein said stanchion further comprises a spring, said spring for biasing said nozzle as said nozzle is directed through said lid aperture.

13. The combination of claim 10 wherein said stanchion comprises a means to release said nozzle, a boom, said boom affixed to said nozzle and engageable with said release means.

14. The combination of claim 13 wherein said release means comprises a lever, said lever for operating said release means.

15. A method of cleaning a tank having an opening utilizing a retractable nozzle movably attached to the tank comprising the steps of:
(a) placing the cleaning apparatus into the tank;
(b) spraying the tank with a fluid passing through the nozzle; and
(c) withdrawing the nozzle from the tank.

16. The method of claim 15 wherein placing the cleaning apparatus in the tank comprises the step of biasing a spring attached thereto.

17. The method of claim 15 wherein placing the cleaning apparatus into the tank comprises the step of releasing the nozzle from the exterior of the tank; and directing the nozzle into the tank through said opening.

18. The method of claim 17 wherein directing the nozzle into the tank through the opening comprises the step of opening a lid covering the opening.
